(19) United States
(12) Patent Application Publication
(10) Pub. No.: US 2008/0058435 A1
(43) Pub. Date: Mar. 6, 2008

(54) Halogen-Fere Flame-Retarded Polymer Foams

(75) Inventors: Markus Allmendinger, Meckenheim (DE); Klaus Hahn, Kirchheim (DE); Joachim Ruch, Wachenheim (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 11/575,033

(22) PCT Filed: Sep. 8, 2005
(86) PCT No.: PCT/EP05/09652

§ 371 Date: Mar. 9, 2007

(30) Foreign Application Priority Data
Sep. 10, 2004 (DE) 10 2004 044 380.7

(51) Int. Cl. C08J 9/14; C08K 5/524

(52) U.S. Cl. 521/107

(57) ABSTRACT

Halogen-free, flame-retardant polymer foams, in particular molded polystyrene foams, composed of expandable polystyrene (EPS) or extruded polystyrene foam sheets (XPS), which comprise, as flame retardant, a phosphorus compound of the general formula (I) 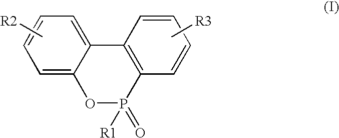 where
R₁, R₂, and R₃, independently of one another, are
H, substituted or unsubstituted C₁-C₁₅-alkyl, substituted or unsubstituted C₁-C₁₅-alkenyl, substituted or unsubstituted C₃-C₈-cycloalkyl, substituted or unsubstituted C₆-C₁₈-aryl, or substituted or unsubstituted C₇-C₃₀-alkylaryl, or the hydrolysis product or metal salt of a phosphorus compound of the general formula (I), and processes for their production.

The invention relates to halogen-free, flame-retardant polymer foams which comprise, as flame retardant, a phosphorus compound of the general formula (I) 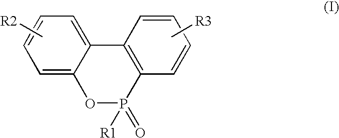
where
R₁, R₂, and R₃, independently of one another, are
H, substituted or unsubstituted C₁-C₁₅-alkyl, substituted or unsubstituted C₁-C₁₅-alkenyl, substituted or unsubstituted C₃-C₈-cycloalkyl, substituted or unsubstituted C₆-C₁₈-aryl, or substituted or unsubstituted C₇-C₃₀-alkylaryl,
or the hydrolysis product or metal salt of a phosphorus compound of the general formula (I), and to processes for their production.

The provision of flame retardants in polymer foams is important for a wide variety of applications, for example for molded polystyrene foams composed of expandable polystyrene (EPS) or extruded polystyrene foam sheets (XPS) for buildings insulation. Halogen-containing, in particular brominated organic compounds have hitherto mainly been used for these polystyrene homo- and copolymers. However, many of these brominated substances are controversial because they are potentially hazardous to the environment and to health.

EP-A 834 529 describes expandable styrene polymers which comprise, as halogen-free flame retardant, a mixture composed of a phosphorus compound and of a water-eliminating metal hydroxide. From 5 to 10% by weight of Mg(OH)₂ and from 5 to 10% by weight of triphenyl phosphate (TPP) are preferably incorporated into molten polystyrene in an extruder, and the material is preferably pelletized and the pellets in aqueous suspension are preferably post-impregnated with blowing agent.

WO 00/34342 describes a process for production of expandable polystyrene via suspension polymerization of styrene in the presence of from 5-50% by weight of expandable graphite and, if appropriate, from 2 to 20% by weight of a phosphorus compound as flame retardant.

The use of 9,10-dihydro-9-oxa-10-phosphaphenanthrene 10-oxide (DOP) and its derivatives for production of transparent, flame-retardant plastics moldings, for example from epoxy resins, from polyester, such as PET, and from styrene polymers, such as ABS, is known from JP-A 2002-06913.

The amount of halogen-free flame retardants which has to be used to achieve the same flame retardancy achieved by halogen-containing flame retardants is generally markedly higher. For this reason, halogen-containing flame retardants capable of use with thermoplastic polymers, such as polystyrene, can frequently not be used for polymer foams because they either disrupt the foaming process or affect the mechanical and thermal properties of the polymer foam. The large amounts of flame retardant can also reduce the stability of the suspension when expandable polystyrene is produced via suspension polymerization.

It is often impossible to predict the effectiveness in polymer foams of the flame retardants used in thermoplastic polymers, because fire behavior is different and the fire tests are different.

It was therefore an object of the invention to find a halogen-free flame retardant which is intended for polymer foams, in particular for expandable polystyrene (EPS) or extruded polystyrene foam sheets (XPS), and which does not significantly affect the foaming process or mechanical properties, and which in particular permits the production of mainly closed-cell polymer foams.

Accordingly, the abovementioned phosphorus compound of the general formula (I) has been found as a flame retardant for polymer foams. The radicals R₁, R₂, and R₃ are preferably, independently of one another, H, methyl, ethyl, tert-butyl, pentyl, hexyl, vinyl, cyclohexyl, α-methylbenzyl, phenyl, 1,4-dihydroxyphenyl, 1,4-dihydroxy-5-(tert-butyl)phenyl, 1,4-dihydroxynaphthyl. Particular preference is given to 9,10-dihydro-9-oxa-10-phosphaphenanthrene 10-oxide (6H-dibenzo[c,e]oxaphosphorine 6-oxide, DOP, CAS reg. no. 35948-25-5), or its hydrolysis product or metal salt. The phosphorus compounds of the formula (I), and their hydrolysis products and metal salts can be prepared, by way of example, as described in JP-A 2004-035495, JP-A 2002-069313, or JP-A 2001-115047.

The amount used of the phosphorus compound of the general formula (I) is generally in the range from 0.5 to 25% by weight, preferably in the range from 5 to 15% by weight, based on the polymer foam.

The effectiveness of the phosphorus compound of the formula (I) can be still further improved via addition of suitable flame retardancy synergists, such as the thermal free-radical generator dicumyl peroxide, di-tert-butyl peroxide, or dicumyl.

Use may also be made of other flame retardants, such as melamine, melamine cyanurates, metal oxides or metal hydroxides, phosphates, phosphinates, or synergists, such as Sb₂O₃, or Zn compounds.

If complete freedom from halogen is not required in the polymer foam, reduced-halogen-level foams can be produced via the use of the phosphorus compound of the formula (I) and addition of relatively small amounts of halogen-containing, in particular brominated flame retardants, such as hexabromocyclodecane (HBCD), preferably in amounts in the range from 0.05 to 1% by weight, in particular from 0.1 to 0.5% by weight.

The density of the halogen-free, flame-retardant polymer foams is preferably in the range from 8 to 200 g/l, particularly preferably in the range from 10 to 50 g/l, and their proportion of closed cells is preferably more than 80%, particularly preferably from 95 to 100%.

The halogen-free, flame-retardant polymer foams preferably comprise a thermoplastic polymer, in particular a styrene polymer.

The inventive halogen-free flame-retardant, expandable styrene polymers (EPS) and extruded styrene polymer foams (XPS) may be produced via mixing to incorporate a blowing agent and a phosphorus compound of the general formula (I) or the hydrolysis product or a metal salt of a phosphorus compound of the general formula (I) into the polymer melt, and then extruding to give foam sheets, foam extrudates, or expandable pellets.

The molar mass of the expandable styrene polymer is preferably in the range from 190 000 to 400 000 g/mol, particularly preferably in the range from 220 000 to 300 000 g/mol. The molar mass of the expandable polystyrene is generally below the molar mass of the polystyrene used by about 10000 g/mol, because molar mass is reduced by shear and/or heat.

Styrene polymers used preferably comprise glass-clear polystyrene (GPPS), impact-resistant polystyrene (HIPS), anionically polymerized polystyrene or impact-resistant polystyrene (A-IPS), styrene-α-methstyrene copolymers, acrylonitrile-butadiene-styrene polymers (ABS), styrene-acrylonitrile (SAN), acrylonitrile-styrene-acrylate (ASA), methacrylate-butadiene-styrene (MBS), methyl methacrylate-acrylonitrile-butadiene-styrene (MABS) polymers, or a mixture of these, or a mixture with polyphenylene ether (PPE).

To improve mechanical properties or heat resistance, the styrene polymers mentioned may, if appropriate with use of compatibilizers, be blended with thermoplastic polymers, such as polyamides (PA), polyolefins, such as polypropylene (PP) or polyethylene (PE), polyacrylates, such as polymethyl methacrylate (PMMA), polycarbonate (PC), polyesters, such as polyethylene terephthalate (PET) or polybutylene terephthalate (PBT), polyether sulfones (PES), polyether ketones, or polyether sulfides (PES), or a mixture of these, generally in total proportions of at most 30% by weight, preferably in the range from 1 to 10% by weight, based on the polymer melt. Mixtures are also possible in the specified range of amounts with, by way of example, hydrophobically modified or functionalized polymers or oligomers, rubbers, such as polyacrylates or polydienes, e.g. styrene-butadiene block copolymers, or biodegradable aliphatic or aliphatic/aromatic copolyesters.

Examples of suitable compatibilizers are organosilanes or polymers containing epoxy groups, or maleic-anhydride-modified styrene copolymers.

The styrene polymer melt may also comprise recycled polymers from the thermoplastic polymers mentioned, in particular styrene polymers and expandable styrene polymers (EPS), admixed in amounts which do not significantly impair their properties, generally in amounts of at most 50% by weight, in particular in amounts of from 1 to 20% by weight.

The styrene polymer melt comprising blowing agent generally comprises one or more blowing agents homogeneously dispersed in a total proportion of from 2 to 10% by weight, preferably from 3 to 7% by weight, based on the styrene polymer melt comprising blowing agent. Suitable blowing agents are the physical blowing agents usually used in EPS, e.g. aliphatic hydrocarbons having from 2 to 7 carbon atoms, alcohols, ketones, ethers, or halogenated hydrocarbons. Preference is given to use of isobutane, n-butane, isopentane, or n-pentane. For XPS, preference is given to use of CO₂ or a mixture with alcohols or with ketones.

To improve foamability, finely dispersed internal water droplets may be introduced into the styrene polymer matrix. By way of example, this may be achieved via addition of water into the molten styrene polymer matrix. Addition of water may take place at a location upstream of, identical with, or downstream of the location of blowing agent feed. Homogeneous dispersion of the water can be achieved by means of dynamic or static mixers.

A sufficient amount of water, based on the styrene polymer, is generally from 0 to 2% by weight, preferably from 0.05 to 1.5% by weight.

Expandable styrene polymers (EPS) with at least 90% of the internal water in the form of internal water droplets with a diameter in the range from 0.5 to 15 μm form, on foaming, foams with a sufficient number of cells and a homogeneous foam structure.

The amount added of blowing agent and of water is selected in such a way that the expandable styrene polymers (EPS) have an expansion capability α, defined as bulk density prior to foaming/bulk density after foaming, of at most 125, preferably from 25 to 100.

The bulk density of the inventive expandable styrene polymer pellets (EPS) is generally at most 700 g/l, preferably in the range from 590 to 660 g/l. If fillers are used, bulk densities in the range from 590 to 1200 g/l can arise, depending on the nature and amount of the filler.

Other materials which may be added to the styrene polymer melt are additives, nucleating agents, fillers, plasticizers, soluble and insoluble inorganic and/or organic dyes and pigments, e.g. IR absorbers, such as carbon black, graphite, or aluminum powder, jointly or separately, e.g. by way of mixers or ancillary extruders. The amounts generally added of the dyes and pigments are in the range from 0.01 to 30% by weight, preferably in the range from 1 to 5% by weight. To give homogeneous and microdisperse distribution of the pigments within the styrene polymer, it can be advantageous, in particular in the case of polar pigments, to use a dispersing agent, e.g. organosilanes, polymers containing epoxy groups, or maleic-anhydride-grafted styrene polymers. Preferred plasticizers are mineral oils, or phthalates, Which may be used in amounts of from 0.05 to 10% by weight, based on the styrene polymer.

To prepare the inventive expandable styrene polymers, the blowing agent is incorporated by mixing into the polymer melt. The process comprises the stages of a) melt production, b) mixing, c) cooling, d) conveying, and e) pelletizing. Each of these stages may be executed via the apparatus or apparatus combinations known in plastics processing. Suitable equipment for incorporation by mixing is static or dynamic mixers, for example extruders. The polymer melt may be directly taken from a polymerization reactor or produced directly in the mixing extruder or in a separate melting extruder via melting of polymer pellets. The cooling of the melt may take place in the mixing assemblies or in separate coolers. Examples of pelletizing processes which may be used are underwater pelletizing under pressure, pelletizing with rotating knives and cooling via spray-misting with temperature-control liquids, or spray pelletizing. Examples of suitable arrangements of apparatus for carrying out the process are:
a) polymerization reactor—static mixer/cooler—pelletizer
b) polymerization reactor—extruder—pelletizer
c) extruder—static mixer—pelletizer
d) extruder—pelletizer

The arrangement may also have ancillary extruders for introducing additives, e.g. solids or heat-sensitive additives.

The styrene polymer melt comprising blowing agent is generally conveyed at a temperature in the range from 140 to 300° C., preferably in the range from 160 to 240° C., through the die plate. There is no need for cooling to the region of the glass transition temperature.

The die plate is heated at least to the temperature of the polystyrene melt comprising blowing agent. The temperature of the die plate is preferably in the range from 20 to 100° C. above the temperature of the polystyrene melt comprising blowing agent. This inhibits formation of polymer deposits in the dies and ensures that pelletizing is not disrupted.

In order to obtain marketable pellet sizes, the diameter (D) of the die orifices at the die outlet should be in the range from 0.2 to 1.5 mm, preferably in the range from 0.3 to 1.2 mm, particularly preferably in the range from 0.3 to 0.8 mm. This method can also give precise adjustment to pellet sizes below 2 mm, in particular in the range from 0.4 to 1.4 mm, after die swell.

Particular preference is given to a process for production of halogen-free flame-retardant, expandable styrene polymers (EPS), comprising the following steps:
a) mixing to incorporate an organic blowing agent and from 1-25% by weight of a phosphorus compound of the general formula (I) or the hydrolysis product or metal salt of a phosphorus compound of the general formula (I) into the polymer melt by means of static or dynamic mixer at a temperature of at least 150° C.,
b) cooling the styrene polymer melt comprising blowing agent to a temperature of at least 120° C.,
c) discharge via a die plate with holes whose diameter at the die outlet is at most 1.5 mm, and
d) pelletizing the melt comprising blowing agent directly downstream of the die plate under water at a pressure in the range from 1 to 20 bar.

It is also possible to prepare the inventive expandable styrene polymers (EPS) via suspension polymerization.

In suspension polymerization, the monomer used preferably comprises only styrene. However, up to 20% of its weight may have been replaced by other ethylenically unsaturated monomers, such as alkylstyrenes, divinylbenzene, acrylonitrile, 1,1-diphenyl ether or α-methylstyrene.

In the suspension polymerization process, the usual auxiliaries may be added, examples being peroxide initiators, suspension stabilizers, blowing agents, chain transfer agents, expansion aids, nucleating agents, and plasticizers. The amounts of the phosphorus compound of the formula (I) added during the polymerization process are from 0.5 to 25% by weight, preferably from 5 to 15% by weight. The amounts of blowing agents added are from 3 to 10% by weight, based on monomer. They may be added prior to, during, or after the polymerization of the suspension. Suitable blowing agents are aliphatic hydrocarbons having from 4 to 6 carbon atoms. It is advantageous for the suspension stabilizers used to comprise inorganic Pickering dispersing agents, e.g. magnesium pyrophosphate or calcium phosphate.

The suspension polymerization gives bead-like, in essence round particles with an average diameter in the range from 0.2 to 2 mm.

To improve processability, the finished expandable styrene polymer pellets may be coated with glycerol esters, antistatic agents, or anticaking agents.

The EPS pellets may be coated with glycerol monostearate GMS (typically 0.25%), glycerol tristearate (typically 0.25%), Aerosil R972 fine-particle silica (typically 0.12%), or Zn stearate (typically 0.15%), or else with antistatic agent.

In a first step, hot air or steam may be used to prefoam the inventive expandable styrene polymer pellets to give foam beads whose density is in the range from 8 to 100 g/l, and in a second step the material may be fused in a closed mold to give molded foams.

The expandable polystyrene beads may be processed to give polystyrene foams whose densities are from 8 to 200 g/l, preferably from 10 to 50 g/l. For this, the expandable beads are prefoamed. This mostly takes place via heating of the beads with steam in what are known as prefoamers. The resultant prefoamed beads are then fused to give moldings. For this, the prefoamed beads are introduced into molds which do not close to give a gastight seal and are treated with steam. After cooling, the moldings can be removed.

### EXAMPLES

### Example 1-3

9,10-Dihydro-9-oxa-10-phosphaphenanthrene 10-oxide (DOP) premixed in a polystyrene melt was fed as stated in Table 1 (amounts added in percent by weight, based on polystyrene) by way of a sidestream extruder into a mainstream of a polystyrene melt comprising blowing agent (PS 148G from BASF Aktiengesellschaft with a viscosity number VN of 83 ml/g, M_{w}=220 000 g/mol, polydispersity M_{w}/Mₙ=2.8, and 7% by weight of n-pentane) after cooling from an initial 260° C. to a temperature of 190° C. The resultant polystyrene melt was conveyed at 60 kg/h through a die plate with 32 holes (diameter 0.75 mm). Compact pellets with narrow size distribution were produced by underwater pelletization under pressure.

### Example 4

Example 3 was repeated, except that hexabromocyclodecane (HBCD, 0.2% by weight, based on EPS pellets) was also fed by way of the sidestream extruder.

### Example 5

Example 3 was repeated, except that dicumyl peroxide (0.5% by weight, based on EPS pellets) was also fed by way of the sidestream extruder.

### Example 6

4.55 kg of polystyrene (PS 158K from BASF) were dissolved in 15.03 kg of styrene and treated with 9,10-dihydro-9-oxa-10-phosphaphenanthrene 10-oxide (DOP) (10% by weight, based on the total amount of styrene and polystyrene). 45.6 g of dicumyl peroxide and 18.1 g of dibenzoyl peroxide were also added. This organic phase was introduced into 19.5 1 of demineralized water in a 50 l stirred tank. The aqueous phase comprised 69.8 g of sodium pyrophosphate and 129.5 g of magnesium sulfate. The suspension was then heated to 80° C. After 140 minutes, 3.51 g of emulsifier K30 (Bayer AG) were added. After a further 30 minutes, 1175 g of pentane were fed and polymerization was completed at 134° C. The resultant EPS beads had an average diameter of 1.2 mm.

The EPS pellets obtained in the examples were prefoamed in a current of steam to give foam beads with a density of about 15 g/l, placed in intermediate storage for 24 hours, and then fused in gas-tight molds using steam, to give foam moldings.

Before fire behavior was studied, the test specimens were stored for at least 72 hours. For assessment of fire behavior, the foam moldings were exposed to a Bunsen burner flame for 2 seconds in a horizontal fire test and then removed from the flame. The afterflame times were determined.

TABLE 1
Fire behavior of foam moldings

| | | Afterflame time |
|---|---|---|
| Example | DOP [%] | [sec.] |
| 1 | 25 | 1 |
| 2 | 15 | 3 |
| 3 | 10 | 10 |
| 4 | 10 | 3 |
| 5 | 10 | 6 |
| 6 | 10 | 10 |

1.-11. (canceled)

12. A halogen-free, flame-retardant polymer foam which comprises, as flame retardant, a phosphorus compound of the general formula (I) 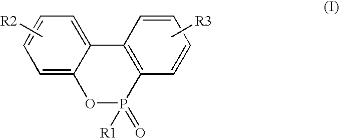
wherein
R1, R2, and R3, independently of one another, are
H, methyl, ethyl, tert-butyl, pentyl, hexyl, vinyl, cyclohexyl, α-methylbenzyl, phenyl, 1,4-dihydroxyphenyl, 1,4-dihydroxy-5-(tert-butyl)phenyl, 1,4-dihydroxynaphthyl, or the hydrolysis product or metal salt of a phosphorus compound of the general formula (I).

13. The halogen-free, flame-retardant polymer foam according to claim 12, which comprises, as flame retardant, 9,10-dihydro-9-oxa-10-phosphaphenanthrene 10-oxide, or its hydrolysis product or metal salt.

14. The halogen-free, flame-retardant polymer foam according to claim 12, which comprises an amount in the range from 0.5 to 25% by weight, based on the polymer foam, of the phosphorus compound of the general formula (I).

15. The halogen-free, flame-retardant polymer foam according to claim 13, which comprises an amount in the range from 0.5 to 25% by weight, based on the polymer foam, of the 9,10-dihydro-9-oxa-10-phosphaphenanthrene 10-oxide, or its hydrolysis product or metal salt.

16. The halogen-free, flame-retardant polymer foam according to claim 12, wherein the foam has a density is in the range from 8 to 200 g/l.

17. The halogen-free, flame-retardant polymer foam according to claim 15, wherein the foam has a density is in the range from 8 to 200 g/l.

18. The halogen-free, flame-retardant polymer foam according to claim 12, wherein more than 80% of the cells are closed cells.

19. The halogen-free, flame-retardant polymer foam according to claim 12, which comprises, as polymer, a styrene polymer.

20. A process for production of halogen-free flame-retardant, expandable styrene polymers (EPS) or of flame-retardant extruded styrene polymer foams (XPS), which comprises using, as flame retardant, a phosphorus compound of the general formula (I) or the hydrolysis product or metal salt of a phosphorus compound of the general formula (I) 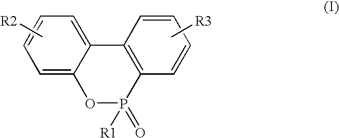
wherein
R1, R2, and R3, independently of one another, are
H, methyl, ethyl, tert-butyl, pentyl, hexyl, vinyl, cyclohexyl, α-methylbenzyl, phenyl, 1,4-dihydroxyphenyl, 1,4-dihydroxy-5-(tert-butyl)phenyl, 1,4-dihydroxynaphthyl, or the hydrolysis product or metal salt of a phosphorus compound of the general formula (I).

21. A process for production of halogen-free flame-retardant, expandable styrene polymers (EPS), comprising the following steps:
a) mixing to incorporate an organic blowing agent and from 1-25% by weight of a phosphorus compound of the general formula (I) or the hydrolysis product or metal salt of a phosphorus compound of the general formula (I) into a styrene polymer melt by means of static or dynamic mixer at a temperature of at least 150° C. 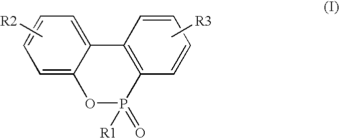
wherein
R1, R2, and R3, independently of one another, are
H, methyl, ethyl, tert-butyl, pentyl, hexyl, vinyl, cyclohexyl, α-methylbenzyl, phenyl, 1,4-dihydroxyphenyl, 1,4-dihydroxy-5-(tert-butyl)phenyl, 1,4-dihydroxynaphthyl,
or the hydrolysis product or metal salt of a phosphorus compound of the general formula (I),
b) cooling the styrene polymer melt comprising blowing agent to a temperature of at least 120° C.,
c) discharge via a die plate with holes whose diameter at the die outlet is at most 1.5 mm, and
d) pelletizing the melt comprising blowing agent directly downstream of the die plate under water at a pressure in the range from 1 to 20 bar.

22. A process for production of halogen-free flame-retardant, expandable styrene polymers (EPS) via polymerization of styrene in an aqueous suspension in the presence of an organic blowing agent and of a flame retardant, which comprises using, as flame retardant, a phosphorus compound of the general formula (I) or the hydrolysis product or metal salt of a phosphorus compound of the general formula (I) 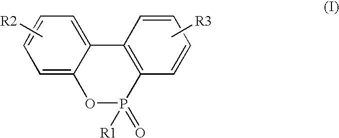
wherein
R1, R2, and R3, independently of one another, are
H, methyl, ethyl, tert-butyl, pentyl, hexyl, vinyl, cyclohexyl, α-methylbenzyl, phenyl, 1,4-dihydroxyphenyl, 1,4-dihydroxy-5-(tert-butyl)phenyl, 1,4-dihydroxynaphthyl, or the hydrolysis product or metal salt of a phosphorus compound of the general formula (I).

23. A halogen-free flame-retardant expandable styrene polymer (EPS), obtainable according to the process as claimed in claim 21.

24. A process for production of halogen-free, flame-retardant polymer foams according to claim 12, which comprises, in a first step, using hot air or steam to prefoam expandable styrene polymers to give foam beads whose density is in the range from 8 to 200 g/l and, in a 2nd step, fusing the materials in a closed mold.
